(19) United States
(12) Patent Application Publication
(10) Pub. No.: US 2013/0103467 A1
(43) Pub. Date: Apr. 25, 2013

(54) Real-Time Content Evaluation and Query Building Processes and Systems

(71) Applicants: David Hills, San Francisco, CA (US); John Donahue, Brooklyn, NY (US); David Simon, New York, NY (US); Julia Parsons, San Francisco, CA (US); Milena Talavera, San Francisco, CA (US); Seph Zdarko, Redwood City, CA (US); Peter O'Sullivan, San Francisco, CA (US)

(72) Inventors: David Hills, San Francisco, CA (US); John Donahue, Brooklyn, NY (US); David Simon, New York, NY (US); Julia Parsons, San Francisco, CA (US); Milena Talavera, San Francisco, CA (US); Seph Zdarko, Redwood City, CA (US); Peter O'Sullivan, San Francisco, CA (US)

(21) Appl. No.: 13/652,353

(22) Filed: Oct. 15, 2012

Related U.S. Application Data
(60) Provisional application No. 61/547,541, filed on Oct. 14, 2011.

(51) Int. Cl. G06Q 30/02

(52) U.S. Cl. CPC G06Q 30/0263
USPC 705/14.6

(57) ABSTRACT

A non-transitory computer readable storage medium includes executable instructions to evaluate a web page to derive a web page scoring schema that is contingent upon selected advertising campaign parameters that establish a unique scoring system of an advertiser. A bid on an advertisement opportunity in the web page based is generated based upon the web page scoring schema.

### CROSS-REFERENCE TO RELATED APPLICATION

This application claims priority to U.S. Provisional Patent Application 61/547,541, filed Oct. 14, 2011, entitled “Real-Time Content Evaluation and Query Building Processes and Systems”, the contents of which are incorporated herein by reference.

### FIELD OF THE INVENTION

The technology disclosed herein relates to networked systems and in particular to online advertising systems.

### BACKGROUND OF THE INVENTION

Online advertising is delivered to rich content environments that may include robust amounts of data regarding the subject matter of the content, the author(s) of that content and associated sentiment. In addition, precise delivery systems for available advertising inventory have created opportunity for real-time decision making at the impression level. For example, online systems today can recognize an ad impression is available on cnn.com about politics and allow an advertiser to purchase or bid on that ad impression based on a contextual category or keyword match.

Content has become more dynamic, more fragmented and more important to advertisers as a means to reaching relevant audiences. However, audience online activities have become more fragmented and restrictions on audience targeting have developed. For example, legislators and regulators are expressing increased concern about online advertising activities that allow for the identities of users to be associated with certain online behaviors and private data. This is resulting in increased limitations on advertisers' ability to target audiences using their historical online behavior. For example, Microsoft® Internet Explorer® and Google® Chrome® have both announced that the next versions of their browser technologies will have default user settings to ‘Do Not Track’, a setting that prevents advertisers from collecting user data from audiences using these browsers. Therefore, advertisers will need alternatives to audience based targeting technologies, for which content targeting is a proven alternative.

Advertisers have two choices when it comes to content targeting methods today, keyword-based advertising or contextual category based advertising. Contextual category advertising systems group URLs into categories. If a user visits a web page of a defined category the system displays an advertisement associated with the category. This can, however, lead to an unfocused advertising campaign, especially if the web pages can each be listed in plural categories or if the web page contents are dynamic and change over time. In addition, categories are general when the advertiser's message or target audience may be specific or different than a competitor that would be required to target the same contextual category.

Keyword-based advertising systems can also deliver misguided advertising. For example, a given keyword might have different meanings in different contexts, yet conventional advertising systems are incapable of distinguishing among these contexts. For example, a search query that includes the word “apple” might be related to one of a wide range of topics, including Apple computer products, New York City, terms of endearment, apple pie or recipes.

Neither existing solution allows for targeting to individual pieces of content based on the entire information available on the page or the unique value of a piece of content to an advertiser relative to their specific message or targeting needs. Although online systems analyze content for topic and keyword matches, these systems disintermediate the precise data about the entire piece of content through categorization systems or limited binary decision making around a match or no match to a keyword or phrase.

Thus, conventional advertising systems cannot determine the relevance of a piece of content relative to an advertisers specific needs or advertising message with sufficient accuracy to deliver targeted advertisements relevant to the viewer of that content. Furthermore, many users have voiced privacy concerns over their click-stream data being collected by central servers. These concerns have led to many users to remove the background programs from their computers. Advertisements delivered by conventional targeted advertising systems are, therefore, commonly dismissed and ignored by users.

### SUMMARY OF THE INVENTION

A non-transitory computer readable storage medium includes executable instructions to evaluate a web page to derive a web page scoring schema that is contingent upon selected advertising campaign parameters that establish a unique scoring system of an advertiser. A bid on an advertisement opportunity in the web page based is generated based upon the web page scoring schema.

### BRIEF DESCRIPTION OF THE FIGURES

The invention is more fully appreciated in connection with the following detailed description taken in conjunction with the accompanying drawings, in which:

FIG. 1 illustrates a conventional online advertising system.

FIG. 2 illustrates a prior art method by which a contextual online advertiser system can target irrelevant content using binary keyword matching methods.

FIG. 3 illustrates a prior art method by which existing contextual analysis for online advertising can result in absolute values and disintermediation from actual value of content to an advertiser.

FIG. 4 illustrates an exemplary system for implementing an embodiment of the present invention.

FIG. 5 illustrates a system for targeting content based on individual content scores and advertiser inputs in accordance with an embodiment of the invention.

FIG. 6 a block diagram showing the system architecture of an embodiment of the invention.

Like reference numerals refer to corresponding parts throughout the several views of the drawings.

### DETAILED DESCRIPTION OF THE INVENTION

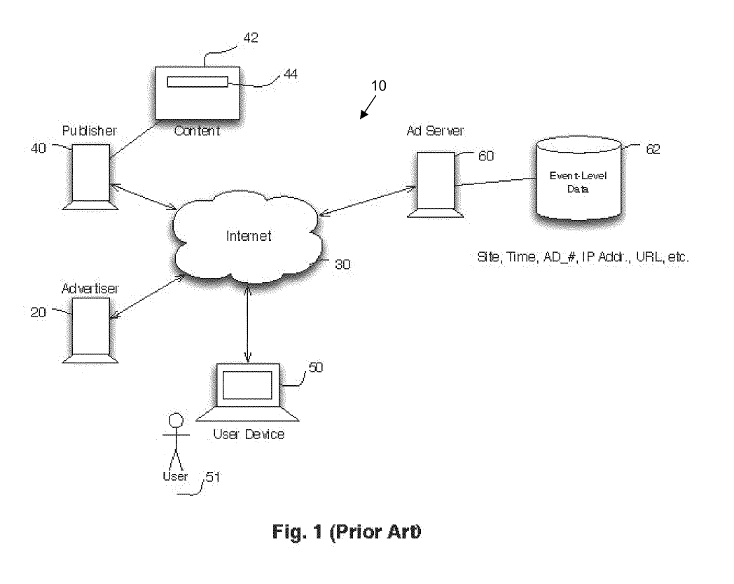

FIG. 1 illustrates a conventional online advertising system by which users who access various websites on the Internet are presented with one or more advertisements. In the online advertising system 10 illustrated, an advertiser 20 desires to advertise its products or services to one or more potential customers. As will be appreciated by those skilled in the art of online advertising, the advertiser 20 typically contracts with an advertising agency to develop a campaign of advertisements that includes both the content of the ads and a plan for where and when those ads should be placed. In many instances, the ads are placed with a number of online publishers 40 having popular websites that are likely seen by a large number of potential customers of the advertiser 20. For example, advertisements may be placed on a home page of a popular website such as “www.cnn.com” or “www.nytimes.com.” Alternatively, advertisements may be placed at more specific sites such as the Home & Garden section of www.nytimes.com or a contextual category like “Home & Garden” made up of groups of content URLs from many different sites.

A user 51 accesses the Internet 30 with a computing device 50 that includes a web browsing program such as Microsoft Internet Explorer, Mozilla Firefox, Google Chrome, Apple Safari and the like. The computing device 50 can be a desktop or laptop computer, mobile computing device such as an Internet capable cellular phone (i.e., smart phone), personal digital assistant (PDA), a tablet, electronic book reader, handheld or console gaming device or the like.

When the user directs a browser program to the website of the publisher 40, the web server downloads a number of markup instructions that inform the user's browser how to render a web page 42. Often the instructions will contain an ad tag that will cause an ad 44 to appear at a designated position, such as in the banner of the web page 42. The ad tag instructs the user's browser to go to an ad server 60 in order to retrieve markup code and graphics to render a particular advertisement for inclusion into the web page 42.

After receiving the markup instructions from the publisher's website 40, the browser program running on the user's computer 50 calls the designated ad server 60. The browser program passes information such as the computer's internet protocol (IP) address, the type of browser program being used, the URL of the page of content being viewed and other information. In cases where content parameters have been defined, such as a set of sites to serve ads to, the ad server 60 then chooses the appropriate advertisement and records an event in an event-level data log that is stored in a database 62 associated with the ad server 60. After the event-level data is recorded, the assets for the selected ad are digitally delivered to the browser program so that the browser can render the web page 42 with the advertisement 44 shown in its correct position.

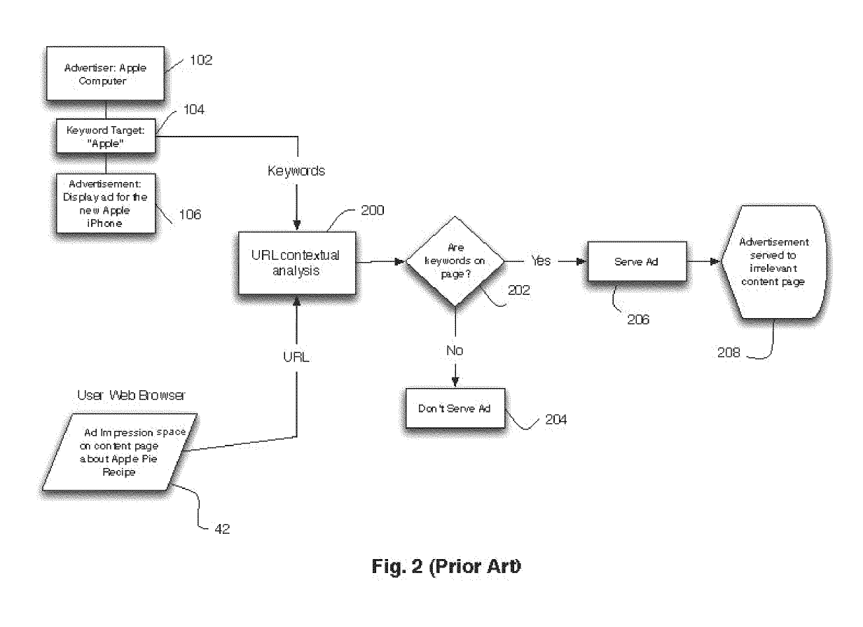

FIG. 2 illustrates one method by which existing contextual analysis for online advertising can result in targeting irrelevant content. In this example the advertiser 102 has provided keyword inputs as targets 104 for a system 200 to identify URL matches for ad placement 208. The system 200 analyzes the content page 42 with ad impression space. The system makes a binary decision 202 as to whether the target keyword 104 is present on the content page 42. If the keyword is not present, the system does not serve an ad 204. If the keyword is present the system serves an ad 206. In the case of the consumer electronics advertiser 102 in this example, Apple® Computer, with the target keyword “Apple” 104 and the content page 42 about an Apple Pie Recipe, the keyword match to the term “Apple” results in an Apple® iPhone® display advertisement 106 on a page about Apple Pie, resulting in an irrelevant ad experience 208 for the user.

Therefore, contextual systems that use limited binary decision making around a match or no match to a keyword or phrase result in serving advertisements to content environments irrelevant to the advertising message and therefore irrelevant to the user viewing that content.

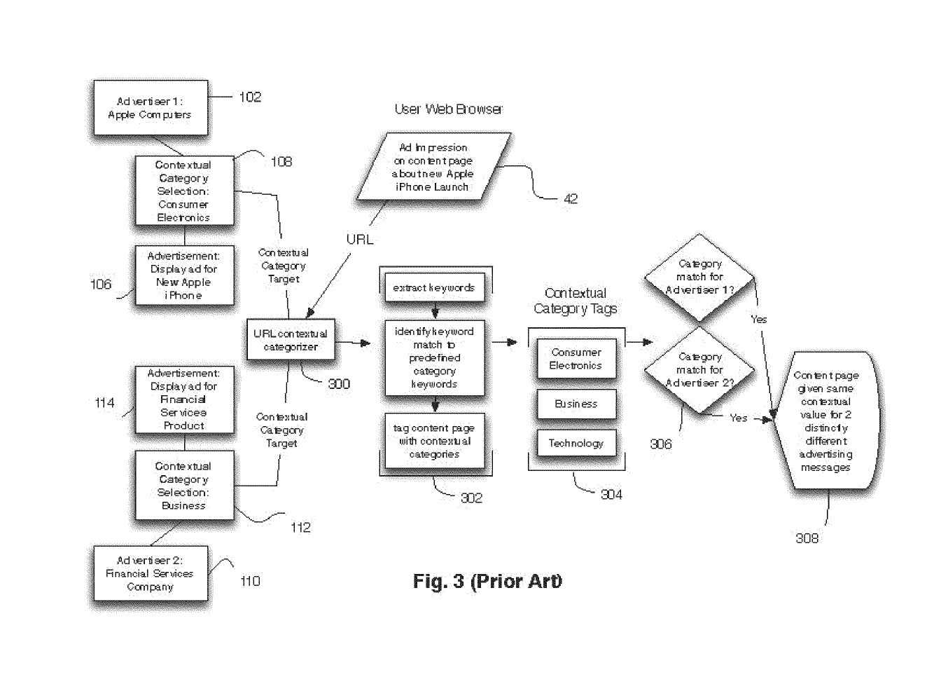

FIG. 3 illustrates how another method for contextual analysis for online advertising can result in absolute values and disintermediation from actual context of content, therefore tagging content for two different advertisers with two different messages, with the same absolute value and ad placement result. For example, Advertiser 1 102 is Apple® Computer with a contextual category selection of “Consumer Electronics” 108 and a display advertisement for the New Apple® iPhone® 106. And where Advertiser 2 110 is a Financial Services Company with a contextual category selection of “Business” 112 and a display advertisement for a Financial Services Product 114, the system 300 goes through a keyword extraction and category tagging process 302 that determines if the content page 42 with the advertising impression opportunity matches the advertiser contextual category selection. The content page about an Apple® iPhone® Launch is tagged with contextual categories 304 “Consumer Electronics”,

“Business” and “Technology” resulting in a match for both Advertiser 1 and Advertiser 2 306. However, the contextual match of the content page is higher for Advertiser 1 102 than for Advertiser 2 110.

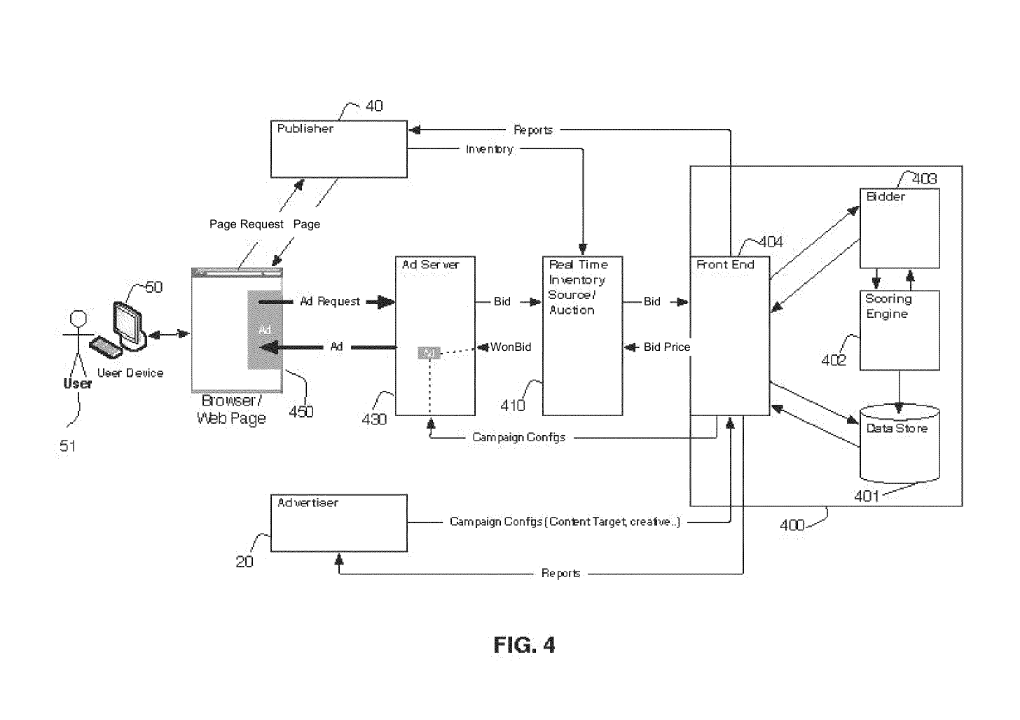

FIG. 4 is an exemplary system for implementing an embodiment of the present invention. A computer system 400 is configured to listen for Advertisement Bid Opportunities from computer system 410 (Real Time Inventory Sources). Preferably, the two systems are either in physical proximity of each other or have network peering set up to accommodate a specified response time (e.g., 10 ms) established by computer system 410. Each Bid Opportunity message sent by computer system 410 includes a PAGE URL field.

Computer system 400 utilizes the page URL to first identify the relevancy of that page as it relates to an Advertiser 20. There is a one to many mapping between a Relevancy Score of a page and an Advertiser 20. Any given page may be relevant to zero, one or many advertisers 420.

Computer system 400 has a front end 404 that accesses the Bidder 403 component of the computer system 400 to identify if the page URL has been seen and analyzed in the past. If the page URL is not new and it is relevant to at least one active Advertiser 20, the Bidder 403 returns the price computer system 400 is willing to pay for the bid opportunity based on what is currently stored within the Bidder 403 data store. If the page URL is relevant to multiple Advertisers 20, the system can be configured to return X number of highest bids.

If computer system 400 is unable to find the page URL within the Bidder component, the page URL is sent to the Scoring engine 402 of the computer system 400. The scoring engine 420 downloads the content behind the URL and calculates relevancy of the page against criteria specified by each active Advertiser 420. The price for any URL/Advertiser combination may be calculated by a mathematical combination of relevancy score and historical Click Through Rate (CTR), price paid, site quality, etc. for a given page. The historical data is retrieved from the computer system 400 Data warehouse 401.

Once computer system 400 returns the bid price(s), Real Time Inventory Source 410 submits the bid into an auction. Typically the highest bid price will win. The Real Time Inventory Source 410 sends the winning bid to an Ad Server 430, which based on parameters passed within the bid, determines the Ad Unit/Creative/Advertiser that corresponds to the given winning bid. The Ad Server 430 sends the Ad Unit to the browser 450 on User Device 50. The Device 50 can be a PC, tablet, smartphone, etc. The browser 450 displays the Ad Unit on a page that the User 51 is looking at via a Device 50.

The Publisher 40 hosts the page the User 51 is browsing. In order for publisher pages to be considered within the bidding process and auctions described above, the Publisher 40 submits its inventory (URL Pages) to Real Time Inventory Sources 410.

In order for the Advertiser 20 to be considered within the bidding process described above, the Advertiser 20 configures an advertising campaign with computer system 400 via a User Interface 404. Advertiser Campaign configurations contribute towards a calculation of the URL/Advertiser score and price.

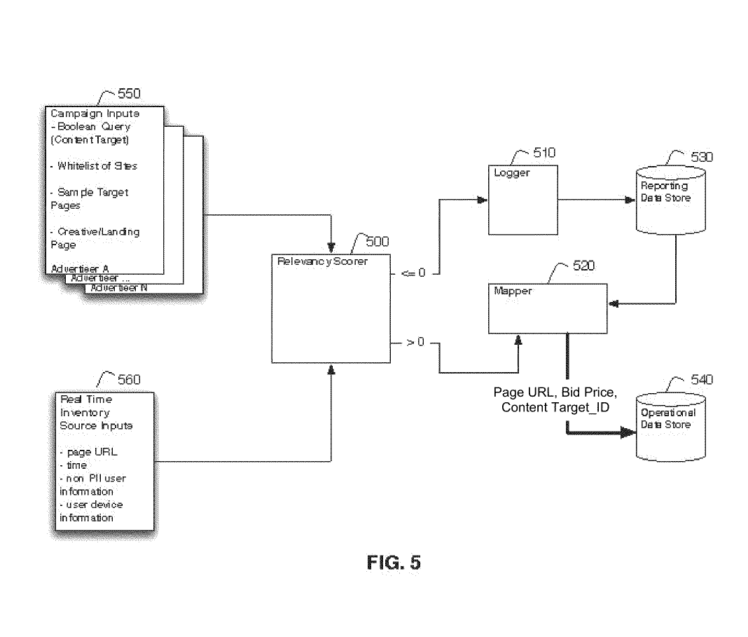

As noted, analyzing content with absolute values in an attempt to identify the value to an advertiser, as is done in prior art, is insufficient to select an appropriate targeted advertisement. In contrast, embodiments of the present invention analyze a plurality of advertiser inputs and content data to determine the relative value of an ad placement for an advertiser. FIG. 5 illustrates some of the concepts underlying the present invention. At least one scoring component 500 of the computer system 400 expects a series of inputs. Some of the inputs are optional and some are required. As seen in FIG. 5, there are two primary input source types into the scoring module 500: The Real Time Inventory Source inputs 560 and campaign inputs 550.

The first type of input source described is the Real Time Inventory Source 560. Computer system 400 can be configured to receive communication from multiple Real Time Inventory Sources 560. Computer system 400 listens for incoming messages from Real Time Inventory Source(s) 560 and adds the messages to a message queue that the Scoring module 500 subscribes to. The messages from the Real Time Inventory Sources 560 will typically include the following: page URL, time of request, user information and user device information. Scorer module 500 requires the page URL information. All other information in the message is optional.

The second type of input source is the campaign input type 550. There is a unique set of inputs per Advertiser. Each advertiser can have one or more unique input sets. In one embodiment, each input set is made up of the following: Boolean Query (Content Target), White list of Sites, Creative, Landing Page, and Sample set of Target Pages. In one embodiment, the only required inputs are the Boolean Query and the Whitelist of sites.

The Scoring module 500 subscribes to the message queue that aggregates the inputs from campaign Inputs 550 and Real Time Inventory Source Inputs 560. Once a message is popped off the message queue, the page URL is compared against a whitelist of sites. If it passes the whitelist filter, then the Relevancy Scorer 500 calculates whether the page URL from Real Time Inventory Source Input is relevant to any of the Advertisers and to what extent. A score is assigned to each unique page URL/Content Target pair. Any number of techniques may be used to calculate the score for each page URL/Content Target pair. If a sample set of Target pages is also provided, then a “More Like This” algorithm may be used to identify an additional Boolean query (Content Target) that will also be assigned a relevancy score.

The URL/Content Target pairs with a zero or negative contextual relevancy score are added to a Logging message queue 510. The modules that subscribe to the Logging message queue are responsible for adding data to the reporting data store 530. The URL/Content Target pairs with a positive contextual relevancy score are sent to the Mapper Module 520 message queue for further analysis.

The Mapper Module 520 is a service that subscribes to the Mapper queue and pulls messages off the queue for processing. The high level function of the Mapper 520 is to produce a price or a price segment for each page URL/Content Target pair. The Mapper service 520 is configured with a bidding algorithm that takes as inputs historical page level and site level data from the Reporting Data store 530, optimization strategy and the relevancy score of the page URL/Content Target pair. Examples of historical page level and site level data include but are not limited to cost, click through rate, relevancy scores, site quality ranking, impression volume, and win/loss ratio. The output of the Mapper 520 is sent to the Logging Message Queue 510 as well as to an in memory operational data store 540 for quick (e.g., sub-10 ms) retrieval by the Bidder 403 which is described in more detail in FIG. 4.

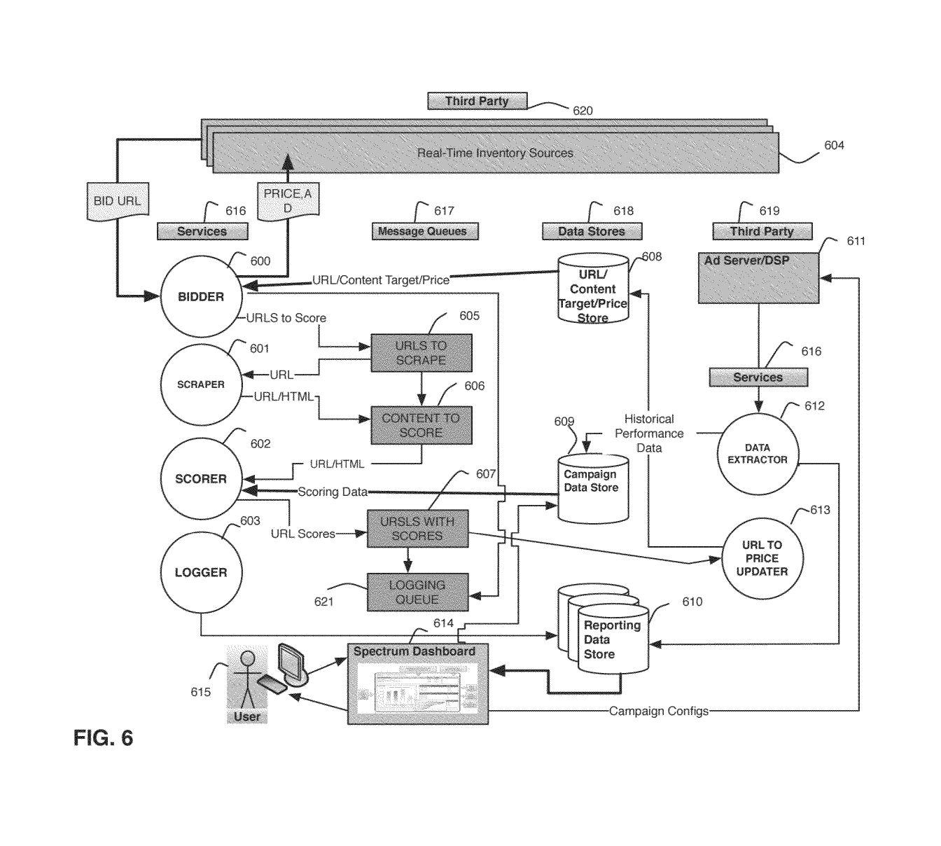

FIG. 6 is a block diagram showing the system architecture of a preferred embodiment of the invention. A more detailed discussion of various aspects of the architecture is provided below. In one embodiment, the architecture comprises Services 616, Message Queues 617, Data Stores 618, Dashboard 614, User 615 and Third Party Services 620. Communication between Services 616 and Third Party Services 620 may be done using HTTP and HTTPS protocols via public Internet. Communication between Services 616, Message Queues 617 and Data Stores 618 may be done via Intranet using HTTP, HTTPS and UDP protocols. Communication between Dashboard 614 and Third Party Services 620 and Data Stores 618 may be done via HTTP and HTTPS protocols via the public Internet.

The Services 616 are hosted on one or more servers. The Bidder 600 subscribes to Bid messages from the Real Time Inventory Sources 604 and has strict response requirements (e.g., 10 milliseconds or less). Such a low latency requirement calls for either physical proximity to the Third Party servers that host Real-Time Inventory Sources 604 or specialized network configuration using peering with the Third Party servers 604. The main functionality of Bidder 600 is to rapidly lookup for a given Bid URL the Bid Price for any relevant Advertisers and their Content Targets. If there are no qualified candidates, then a No Bid message is sent back to the Real Time Inventory Source 604. Bidder 600 calls URL/Content Target/Price Store 608 with a Bid URL or a derivative of it (Hash) and the Data Store 608 returns a Bid Price for any relevant Advertisers and their Content Targets. URL/Content Target/Price Store 608 must be an in memory database in order to meet performance requirements.

Message Queues can be implemented a number of ways. One way to do so is to use an open source cross-platform Enterprise messaging system that implements the Advanced Message Queuing Protocol (AMQP). Clustering and distribution of the message queue implementation allow for scaling of the system.

Once Bidder 600 responds to the Real Time Inventory Sources 604, the Bidder 600 adds a message to the Logging Queue 621 and the URLs to Scrape Queue 605. The Logging Queue 621 and Logger Service 603 are used to store information about Bids and Bid Opportunities in a Central Reporting Data Store 610. Reporting Data Store 610 is a multi-node, massively parallel data store that can support storage and querying of multiple terabytes of data. URLs to Score Message Queue 605 and Scraper Service 601 determine whether a Bid URL needs to be scraped/re-scraped. If it does, the Scraper 601 will download the page content and add a message to the Content To Score Queue 606. The role of Content to Score Queue 606 and the Scorer Service 602 is to calculate contextual relevancy of the page URL content relative to every active Advertiser, and then apply historical data from Campaign Data Store 609 to calculate Bid Price per every Advertiser Content Target. The Scorer 602 is covered in more detail in FIG. 5.

The output of the Scorer 602 is sent to the URLS with Scores message queue 607. URL to Price Updater Service 613 subscribes to the URLS with Scores queue 607. Together their role is to update the URL/Content Target/Price 608 in-memory data store with the most up to date information.

The User 615 may interface with the invention via Dashboard 614. Dashboard 614 may be a web-based application. The major functionalities of Dashboard 614 may include but are not limited to: User account management and authentication, campaign management and administration, ad-hoc and predefined reporting. More specifically, the Spectrum Dashboard 614 implements APIs to set up Advertisers and their Campaigns within Ad Server/DSPs 611, provides tools to define Advertiser specific Content Targets using information retrieval techniques and Boolean queries.

As it pertains to hardware and scaling, an embodiment of the invention described has the following minimum requirements: Respond to Real-Time Inventory Sources 604 within 10 milliseconds; handle a minimum of 50,000 Bid opportunity requests per second. To support such minimum requirements the system architecture may be distributed, multithreaded and scalable. Network configuration and in-memory data stores may be used to achieve the above requirements. Scale is achieved by implementation of Services in a manner that allows multiple instances of each service to run on one or more servers. The hardware configuration requires a lot of RAM and/or high capacity SSDs to achieve desired levels of performance.

Thus, the disclosed technology includes an online advertising system that has a computer system that receives content data and other event-level data from an ad server computer or computer of another third party providing advertising placement opportunities and corresponding data as well from an advertiser. In one embodiment, the computer system uses a content data identifier or URL as a common link to define a match score between advertiser content inputs and available ad opportunities on similar content matches. Advertisers match scores are unique and relative to advertisers' inputs and ad placements are delivered directly to the page based on a score determined by match and other event-level data. The computer system is therefore able to deliver page-level scoring and ad placement unique and relative to advertiser inputs, in near real-time, without the use of a standard taxonomy or absolute scoring system.

The real-time content system is built for the purpose of scoring web content, relating content scores to bid prices, and integrating into real-time bidding systems. Preferably, the system has a modular design to support integration with a variety of real-time bidding systems, bidders and data providers.

A variety of scores may be supplied in accordance with embodiments of the invention, such as natural and relative score for relevancy, win/loss measure, performance measure, pace measure (pace toward a goal), and a site optimization weight. A bidding formula may be based upon statistics about an overall campaign and campaign goals.

Advertising campaign goals may be used in the evaluation of content. For example, campaign goals related to campaign performance, content relevance, bid price and balance may be used.

The computer system 400 includes a central processing unit (CPU) connected to a bus. Input/output devices are also connected to the bus, and may include a keyboard, mouse, display, and the like. An executable program representing a module for at least part of a real-time content evaluation process and/or system is stored in memory, which is also connected to the bus. Executable programs representing other modules can also be stored in the memory.

An embodiment of the invention relates to a computer-readable storage medium having computer code thereon for performing various computer-implemented operations. The term “computer-readable storage medium” is used herein to include any medium that is capable of storing or encoding a sequence of instructions or computer codes for performing the operations described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter or a compiler. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) via a transmission channel. Another embodiment of the invention may be implemented in hardwired circuitry in place of, or in combination with, machine-executable software instructions.

While certain conditions and criteria are specified herein, it should be understood that these conditions and criteria apply to some embodiments of the disclosure, and that these conditions and criteria can be relaxed or otherwise modified for other embodiments of the disclosure. References cited herein are incorporated by reference in their entirety.

While the invention has been described with reference to the specific embodiments thereof, it should be understood by those skilled in the art that various changes may be made and equivalents may be substituted without departing from the true spirit and scope of the invention as defined by the appended claim(s). In addition, many modifications may be made to adapt a particular situation, material, composition of matter, method, or process to the objective, spirit and scope of the invention. All such modifications are intended to be within the scope of the claim(s) appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A non-transitory computer readable storage medium, comprising executable instructions to:
evaluate a web page to derive a web page scoring schema that is contingent upon selected advertising campaign parameters that establish a unique scoring system of an advertiser; and
generate a bid on an advertisement opportunity in the web page based upon the web page scoring schema.

2. The non-transitory computer readable storage medium of claim 1 wherein the campaign parameters are selected from a content target query, a white list of web sites, creative parameters, a specified landing page and a sample set of target pages.

3. The non-transitory computer readable storage medium of claim 1 wherein the campaign parameters include campaign goals.

4. The non-transitory computer readable storage medium of claim 3 wherein the campaign goals are selected from a campaign performance measure, a content relevancy measure, a target bid price, and a campaign balance measure.

5. The non-transitory computer readable storage medium of claim 1 wherein the scoring schema is used to map tiered bid prices to predefined advertising context category segments.
